(19) United States
(12) Patent Application Publication
(10) Pub. No.: US 2005/0285796 A1
(43) Pub. Date: Dec. 29, 2005

(54) Notebook computer equipped with a printed circuit antenna

(76) Inventor: Kuo-Chih Lee, Taipei (TW)

Correspondence Address: HARNESS, DICKEY & PIERCE, P.L.C., P.O. BOX 8910, RESTON, VA, 20195, US

(21) Appl. No.: 10/874,179

(22) Filed: Jun. 24, 2004

(51) Int. Cl. H01Q 1/24

(52) U.S. Cl. 343/702

(57) ABSTRACT

A notebook computer equipped with a printed circuit antenna includes a host and a display device pivotally coupled with each other. The display device includes a casing for housing a display screen on a front side thereof and at least one printed circuit antenna. The printed circuit antenna partly masks the top side of the display screen and is installed in a biased manner between the rear side of the casing and the display screen at a higher elevation thereby to increase signal receiving intensity and improve communication quality.

### FIELD OF THE INVENTION

The present invention relates to a notebook computer equipped with a printed circuit antenna and particularly to a notebook computer that has a printed circuit antenna to improve a signal receiving effect and provide a desired communication quality.

### BACKGROUND OF THE INVENTION

With rapid advance of information technologies, research on wireless communication also has a great progress. In recent years many wireless communication standards have been announced, mostly about digital transmission. Digital communication modes have many types. Wireless communication is the main focus in the industry. Wireless network (or called Wireless Lan—WLAN) has the advantages of the longest transmission distance and the widest broadband. In general it can reach more than 30 meters at the broadband of 2 Mbps. Some even can reach 54 Mbps depending on requirements. As multimedia applications are increasingly popular, wireless communication has become the main focus in the future. This is especially true in countries where real estate value is high. Because with a wireless system wires in the building are not needed, many domestic and multinational enterprises have adopted wireless operation systems. The wireless network operation system mode can free users from the office environment. This not only improves the productivity and efficiency of employees, it also reduces office space requirements and total operating costs.

At present handheld data processing devices such as Personal Digital Assistant (PDA) and notebook computers also have a built-in wireless transmission function, in addition to wireless transmission operation through an external wireless network card. The antenna used generally are flat antenna that include even pole antenna and printed circuit antenna.

Take the antenna that is assembled in an exposed manner for instance. The conventional approach is to dispose an even pole antenna that may be turned outwards or folded for storing in a housing trough located on one side or a topside of a notebook computer. For products that are installed inside, the general approach is to embed in a rear lateral side or two lateral sides or the top side of the display device of the notebook computer, or in a turning axle that couples the host and the display device of the notebook computer. There is another approach that locates the antenna close to the hand resting area of the host.

The design of embedding the antenna in the host or display device of the notebook computer has the advantages of appealing profile and easy carrying. However, laying the antenna on the topside often demands increasing the thickness of the display device. It makes the notebook computer bulky and clumsy. The design of having the antenna built on the rear side, two lateral sides, close to the hand resting area of the host, or in the turning axle affects the signal receiving angle and often results in a signal receiving dead angle. Communication quality could suffer.

The foregoing problems commonly occur to the conventional techniques or products which have to be solved.

### SUMMARY OF THE INVENTION

Therefore the primary object of the invention is to provide a notebook computer equipped with a printed circuit antenna to improve signal receiving intensity and eliminate the problem of poor communication quality occurring to conventional techniques.

The notebook computer equipped with a printed circuit antenna according to the invention includes a host and a display device that are pivotally coupled with each other. The host is to perform data processing. The display device generates pictures for user viewing. The display device has a casing to house a display screen on a front side. One or more printed circuit antenna are located on the topside of the display screen and partly mask the display screen, and are installed in a biased manner between the casing and the display screen.

Compared with the conventional techniques that mostly have the antenna located on the rear side of the casing and result in the printed circuit antenna being masked and forming signal receiving dead angles, the invention has the printed circuit antenna installed on a higher elevation of the display device, which results in an improved signal receiving angle and greatly increases signal receiving intensity and provides improved communication quality.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is an exploded view of a notebook computer equipped with a printed circuit antenna of the invention.

FIG. 2 is a fragmentary schematic view of the invention showing an installation condition of the printed circuit antenna.

FIG. 3 is a fragmentary schematic view of the invention showing the printed circuit antenna being coupled by retaining members.

FIG. 4A is a chart showing an experiment result of a conventional printed circuit antenna in a gain mode.

FIG. 4B is a chart showing an experiment result of a printed circuit antenna of the invention in a gain mode at 2.4 Ghz.

FIG. 5A is a chart showing another experiment result of a conventional printed circuit antenna in a gain mode.

FIG. 5B is a chart showing an experiment result of a printed circuit antenna of the invention in a gain mode at 2.45 Ghz.

FIG. 6A is a chart showing yet another experiment result of a conventional printed circuit antenna in a gain mode.

FIG. 6B is a chart showing an experiment result of a printed circuit antenna of the invention in a gain mode at 2.5 Ghz.

### DESCRIPTION OF THE PREFERRED EMBODIMENT

The notebook computer equipped with a printed circuit antenna according to the invention aims to improve signal receiving intensity and communication quality.

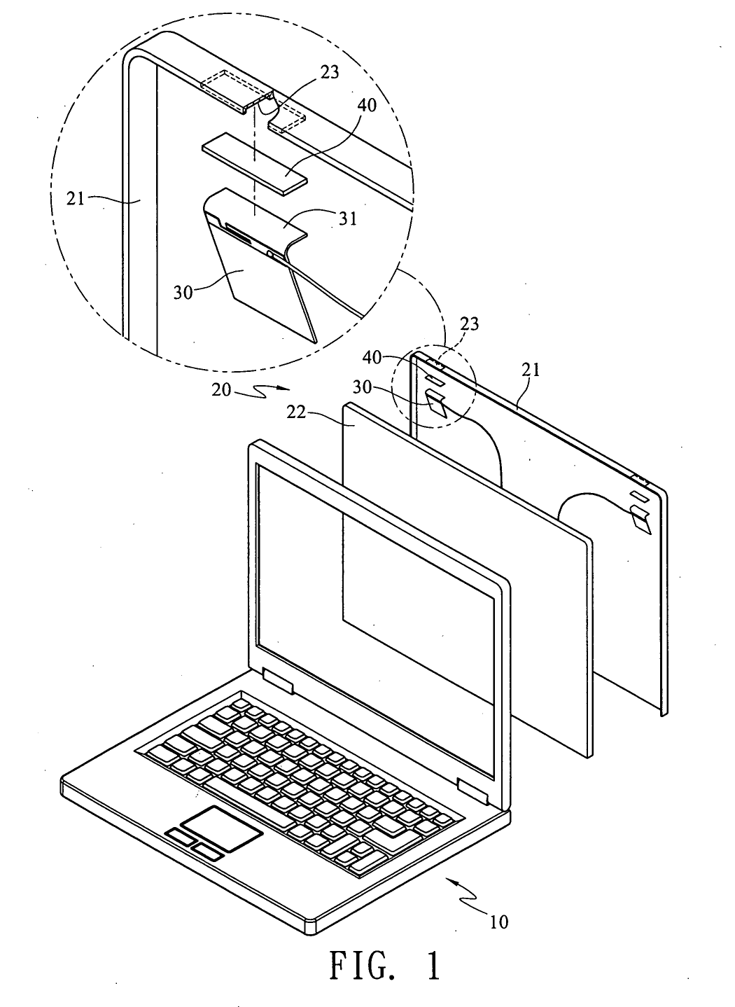

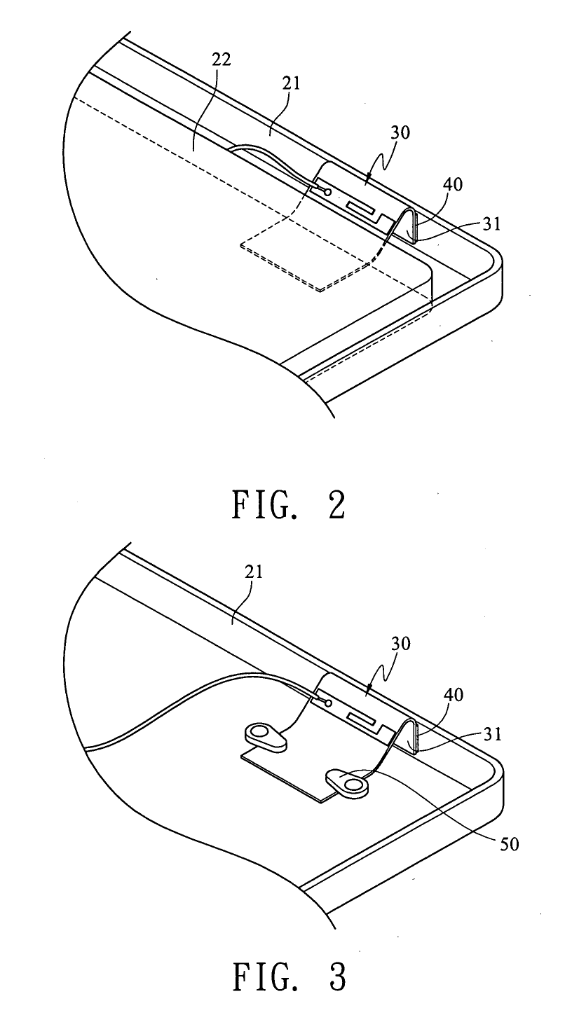

Referring to FIGS. 1 and 2, the invention includes a host 10 and a display device 20 that are pivotally coupled with each other, and one or more printed circuit antenna 30. The host 20 performs data processing. The display device 20 generates pictures for user viewing. The display device 20 has a casing 21 to house a display screen 22 on a front side thereof.

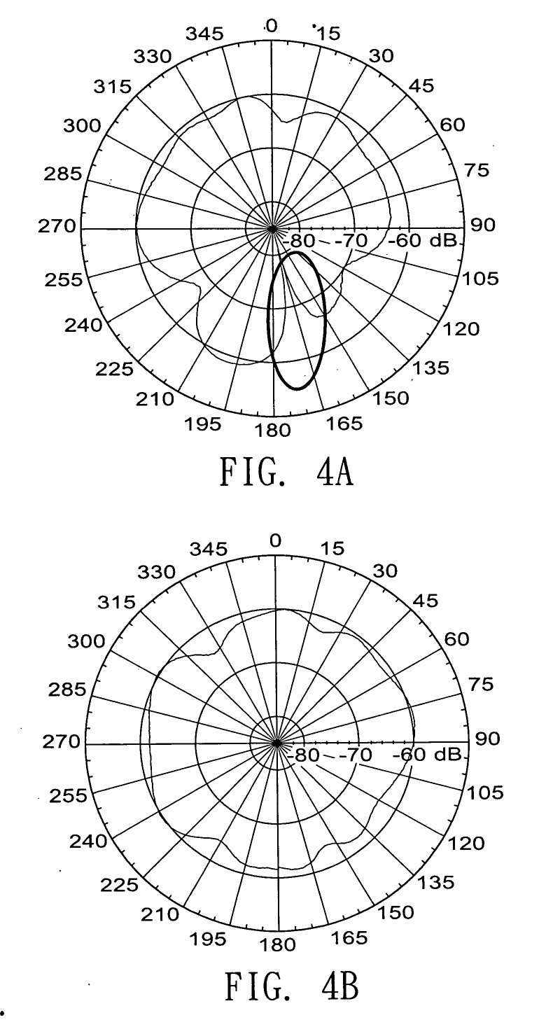

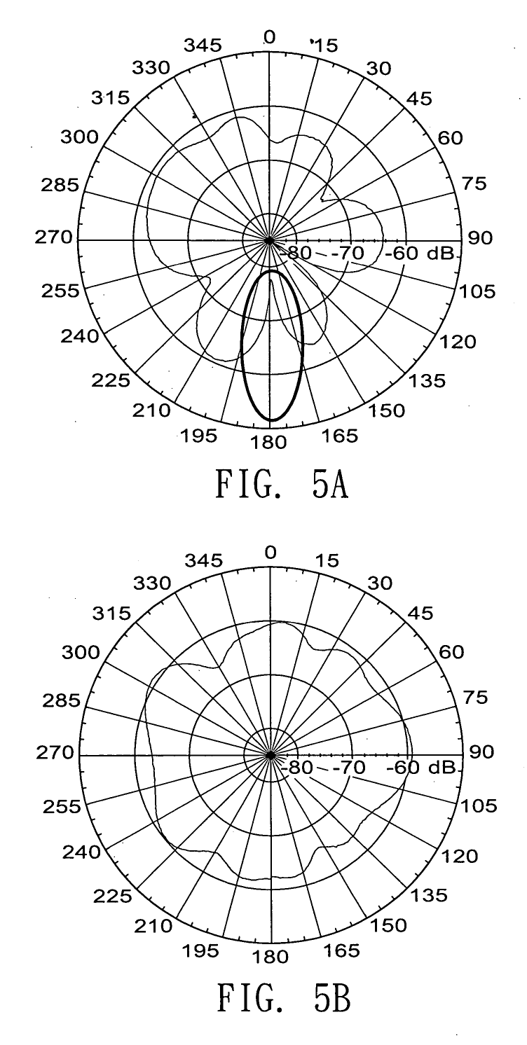

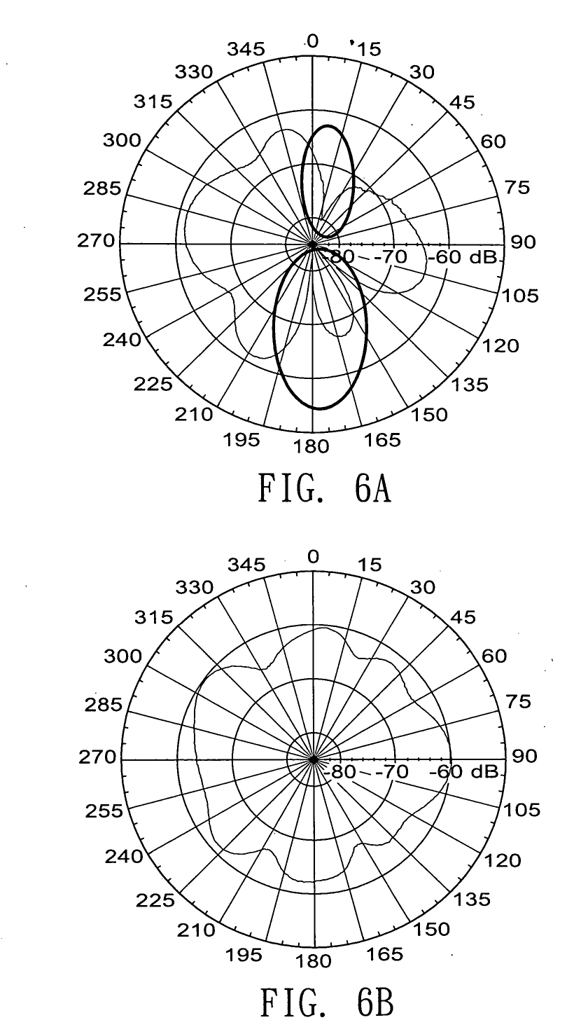

Applicant finds that most conventional techniques have the printed circuit antenna located on a lateral side or the rear side of the casing 21 or in the host 10. Such an arrangement often results in signal receiving dead angles. Refer to FIGS. 4A, 5A and 6A for experiment results of a printed circuit antenna that adopts the conventional techniques in a gain mode at 2.4 Ghz, 2.45 Ghz and 2.5 Ghz. They indicate that an insufficiency occurs in the upper half portion or the lower half portion. Masking of the printed circuit antenna causes this. As a result, communication quality suffers.

A further research and study indicates that the elevation of the printed circuit antenna seems to have a direct proportional relationship with signal receiving intensity. Hence the invention has the printed circuit antenna 30 installed on a higher elevation and partly masks the display screen 22, and installs it in a biased manner between the top side of the display screen 22 and the casing 21.

Namely the printed circuit antenna 30 is located to partly mask the topside of the display screen 22, and installed in a biased manner between the topside of the display screen 22 and the casing 21. Such a design shows an improving signal receiving effect. Referring to FIGS. 4B, 5B and 6B, the experiment results indicate that the insufficiencies of the conventional techniques shown in FIGS. 4A, 5A and 6A are improved in the invention.

In addition, the printed circuit antenna 30 has one side extended to form a coupling section 31. The casing 21 has a slot 23 corresponding to the coupling section 31. A back-glued strip 40 is provided and located on the slot 23. During assemblage, the coupling section 31 and the back-glued strip 40 are bonded together to allow the printed circuit antenna 30 to be bonded securely between the casing 21 and the top side of the display screen 22. Referring to FIG. 3, additional retaining members 50 are included to couple the printed circuit antenna 30 to provide an additional anchoring effect.

The notebook computer equipped with a printed circuit antenna according to the invention alters the installation location of the printed circuit antenna, thereby greatly increasing signal receiving intensity of the printed circuit antenna, and improves the communication quality. It offers a significant improvement on the conventional techniques.

While the preferred embodiments of the invention has been set forth for the purpose of disclosure, modifications of the disclosed embodiment of the invention as well as other embodiments thereof may occur to those skilled in the art. Accordingly, the appended claims are intended to cover all embodiments, which do not depart from the spirit and scope of the invention.

1. A notebook computer equipped with a printed circuit antenna comprising a host for processing data and a display device pivotally coupled with the host for generating pictures, the display device including a casing for housing a display screen on a front side thereof and at least one printed circuit antenna;
wherein the printed circuit antenna partly masks the top side of the display screen and is installed in a biased manner between the casing and the display screen.

2. The notebook computer equipped with a printed circuit antenna of claim 1, wherein the casing has a retaining member corresponding to where the printed circuit antenna is installed to anchor the printed circuit antenna.

3. The notebook computer equipped with a printed circuit antenna of claim 1, wherein the printed circuit antenna is attached to the casing by bonding through adhesive.

4. The notebook computer equipped with a printed circuit antenna of claim 1 further having a back-glued strip located on the location of the casing where printed circuit antenna is installed to allow the printed circuit antenna to be bonded securely on the casing.

5. The notebook computer equipped with a printed circuit antenna of claim 4, wherein the casing has a slot to hold the back-glued strip.

6. The notebook computer equipped with a printed circuit antenna of claim 4, wherein the printed circuit antenna is extended to form a coupling section to bond the back-glued strip.
